(19) United States
(12) Patent Application Publication
(10) Pub. No.: US 2009/0149605 A1
(43) Pub. Date: Jun. 11, 2009

(54) Heterophasic propylene based polymers for forming fiber

(75) Inventors: Fengkui Li, Houston, TX (US); Likuo Sun, Houston, TX (US); William R. Wheat, Houston, TX (US); John O. Bieser, Houston, TX (US)

Correspondence Address: David J. Alexander, P.O.Box 674412, Houston, TX, 77167, US

(73) Assignee: Fina Technology, Inc., Houston, TX (US)

(21) Appl. No.: 11/999,848

(22) Filed: Dec. 7, 2007

(51) Int. Cl. C08L 23/14; C08L 23/12

(52) U.S. Cl. 525/240

(57) ABSTRACT

Fibers and articles formed therefrom are described herein. The fibers generally include a first polymer including a first propylene based impact copolymer and a second propylene based polymer.

### FIELD

Embodiments of the present invention generally relate to heterophasic propylene based polymers for use in the production of nonwoven fabrics and continuous filaments.

### BACKGROUND

Heterophasic copolymers (impact copolymers (ICP)) are generally used in applications requiring impact strength, such as molded and extruded automobile parts, household appliances, luggage and furniture, for example. Impact copolymers may also be used to make cast or blown films for packaging applications. However, such impact copolymers have not been widely used in the manufacture of fibers and spunbond nonwoven fabrics (processes wherein manufacturers focus on properties such as processibility, strength and softness, for example).

Nonwoven articles and continuous filaments have been made of polypropylene based polymers due to its low cost, easy processability and superior physical properties. However, it would be beneficial to develop heterophasic copolymer formulations with improved spinnability for making fine denier fibers. It would also be beneficial to develop impact copolymer formulations that can exhibit self crimping so that the spunbond fabrics are capable of exhibiting increasing cover, resilience, abrasion resistance, warmth, insulation, moisture absorption or the ability to provide a different surface texture, for example

### SUMMARY

Embodiments of the present invention include fibers. The fibers generally include a first polymer including a first propylene based impact copolymer and a second propylene based polymer.

In one or more embodiments, the first polymer and the second polymer are blended together and vis-broken to form a blend.

Embodiments of the invention further include filaments. The filaments generally include a propylene based impact copolymer including from about 3 wt. % to about 15 wt. % ethylene.

### BRIEF DESCRIPTION OF DRAWINGS

FIG. 1 illustrates partially oriented fibers formed from impact copolymers including 6 wt. % ethylene.

FIG. 2 illustrates partially oriented fibers formed from impact copolymers including 9 wt. % ethylene.

FIG. 3 illustrates partially oriented fibers formed from impact copolymers including 11.5 wt. % ethylene.

FIG. 4 illustrates continuous filaments formed from a propylene homopolymer.

FIG. 5 illustrates continuous filaments formed from an impact copolymer.

### DETAILED DESCRIPTION

### Introduction and Definitions

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions when the information in this patent is combined with available information and technology.

Various terms as used herein are shown below. To the extent a term used in a claim is not defined below, it should be given the broadest definition persons in the pertinent art have given that term as reflected in printed publications and issued patents at the time of filing. Further, unless otherwise specified, all compounds described herein may be substituted or unsubstituted and the listing of compounds includes derivatives thereof.

Various ranges are further recited below. It should be recognized that unless stated otherwise, it is intended that the endpoints are to be interchangeable. Further, any point within that range is contemplated as being disclosed herein.

As used herein, “room temperature” means that a temperature difference of a few degrees does not matter to the phenomenon under investigation, such as a preparation method. In some environments, room temperature may include a temperature of from about 20° C. to about 28° C. (68° F. to 82° F.), while in other environments, room temperature may include a temperature of from about 50° F. to about 90° F., for example. However, room temperature measurements generally do not include close monitoring of the temperature of the process and therefore such a recitation does not intend to bind the embodiments described herein to any predetermined temperature range.

Embodiments of the invention generally include heterophasic polymers and process of forming the same. As used herein, the term “heterophasic” generally refers to a polymer having two or more phases. The incorporation of the rubber phase into the polymer matrix generally improves impact properties. As a result, the heterophasic polymers may also be referred to as impact copolymers herein.

### Catalyst Systems

Catalyst systems useful for polymerizing olefin monomers include any catalyst system known to one skilled in the art. For example, the catalyst system may include metallocene catalyst systems, single site catalyst systems, Ziegler-Natta catalyst systems or combinations thereof, for example. As is known in the art, the catalysts may be activated for subsequent polymerization and may or may not be associated with a support material. A brief discussion of such catalyst systems is included below, but is in no way intended to limit the scope of the invention to such catalysts.

For example, Ziegler-Natta catalyst systems are generally formed from the combination of a metal component (e.g., a catalyst) with one or more additional components, such as a catalyst support, a cocatalyst and/or one or more electron donors, for example.

Metallocene catalysts may be characterized generally as coordination compounds incorporating one or more cyclopentadienyl (Cp) groups (which may be substituted or unsubstituted, each substitution being the same or different) coordinated with a transition metal through π bonding. The substituent groups on Cp may be linear, branched or cyclic hydrocarbyl radicals, for example. The cyclic hydrocarbyl radicals may further form other contiguous ring structures, including indenyl, azulenyl and fluorenyl groups, for example. These contiguous ring structures may also be substituted or unsubstituted by hydrocarbyl radicals, such as C₁ to C₂₀ hydrocarbyl radicals, for example.

### Polymerization Processes

As indicated elsewhere herein, catalyst systems are used to form polyolefin compositions. Once the catalyst system is prepared, as described above and/or as known to one skilled in the art, a variety of processes may be carried out using that composition. The equipment, process conditions, reactants, additives and other materials used in polymerization processes will vary in a given process, depending on the desired composition and properties of the polymer being formed. Such processes may include solution phase, gas phase, slurry phase, bulk phase, high pressure processes or combinations thereof, for example. (See, U.S. Pat. No. 5,525,678; U.S. Pat. No. 6,420,580; U.S. Pat. No. 6,380,328; U.S. Pat. No. 6,359,072; U.S. Pat. No. 6,346,586; U.S. Pat. No. 6,340,730; U.S. Pat. No. 6,339,134; U.S. Pat. No. 6,300,436; U.S. Pat. No. 6,274,684; U.S. Pat. No. 6,271,323; U.S. Pat. No. 6,248,845; U.S. Pat. No. 6,245,868; U.S. Pat. No. 6,245,705; U.S. Pat. No. 6,242,545; U.S. Pat. No. 6,211,105; U.S. Pat. No. 6,207,606; U.S. Pat. No. 6,180,735 and U.S. Pat. No. 6,147,173, which are incorporated by reference herein.)

In certain embodiments, the processes described above generally include polymerizing one or more olefin monomers to form polymers. The olefin monomers may include C₂ to C₃₀ olefin monomers, or C₂ to C₁₂ olefin monomers (e.g., ethylene, propylene, butene, pentene, methylpentene, hexene, octene and decene), for example. The monomers may include olefinic unsaturated monomers, C₄ to C₁₈ diolefins, conjugated or nonconjugated dienes, polyenes, vinyl monomers and cyclic olefins, for example. Non-limiting examples of other monomers may include norbornene, nobornadiene, isobutylene, isoprene, vinylbenzocyclobutane, sytrene, alkyl substituted styrene, ethylidene norbornene, dicyclopentadiene and cyclopentene, for example. The formed polymer may include homopolymers, copolymers or terpolymers, for example.

Examples of solution processes are described in U.S. Pat. No. 4,271,060, U.S. Pat. No. 5,001,205, U.S. Pat. No. 5,236,998 and U.S. Pat. No. 5,589,555, which are incorporated by reference herein.

One example of a gas phase polymerization process includes a continuous cycle system, wherein a cycling gas stream (otherwise known as a recycle stream or fluidizing medium) is heated in a reactor by heat of polymerization. The heat is removed from the cycling gas stream in another part of the cycle by a cooling system external to the reactor. The cycling gas stream containing one or more monomers may be continuously cycled through a fluidized bed in the presence of a catalyst under reactive conditions. The cycling gas stream is generally withdrawn from the fluidized bed and recycled back into the reactor. Simultaneously, polymer product may be withdrawn from the reactor and fresh monomer may be added to replace the polymerized monomer. The reactor pressure in a gas phase process may vary from about 100 psig to about 500 psig, or from about 200 psig to about 400 psig or from about 250 psig to about 350 psig, for example. The reactor temperature in a gas phase process may vary from about 30° C. to about 120° C., or from about 60° C. to about 115° C., or from about 70° C. to about 110° C. or from about 70° C. to about 95° C., for example. (See, for example, U.S. Pat. No. 4,543,399; U.S. Pat. No. 4,588,790; U.S. Pat. No. 5,028,670; U.S. Pat. No. 5,317,036; U.S. Pat. No. 5,352,749; U.S. Pat. No. 5,405,922; U.S. Pat. No. 5,436,304; U.S. Pat. No. 5,456,471; U.S. Pat. No. 5,462,999; U.S. Pat. No. 5,616,661; U.S. Pat. No. 5,627,242; U.S. Pat. No. 5,665,818; U.S. Pat. No. 5,677,375 and U.S. Pat. No. 5,668,228, which are incorporated by reference herein.)

Slurry phase processes generally include forming a suspension of solid, particulate polymer in a liquid polymerization medium, to which monomers and optionally hydrogen, along with catalyst, are added. The suspension (which may include diluents) may be intermittently or continuously removed from the reactor where the volatile components can be separated from the polymer and recycled, optionally after a distillation, to the reactor. The liquefied diluent employed in the polymerization medium may include a C₃ to C₇ alkane (e.g., hexane or isobutane), for example. The medium employed is generally liquid under the conditions of polymerization and relatively inert. A bulk phase process is similar to that of a slurry process with the exception that the liquid medium is also the reactant (e.g., monomer) in a bulk phase process. However, a process may be a bulk process, a slurry process or a bulk slurry process, for example.

In a specific embodiment, a slurry process or a bulk process may be carried out continuously in one or more loop reactors. The catalyst, as slurry or as a dry free flowing powder, may be injected regularly to the reactor loop, which can itself be filled with circulating slurry of growing polymer particles in a diluent, for example. Optionally, hydrogen may be added to the process, such as for molecular weight control of the resultant polymer. The loop reactor may be maintained at a pressure of from about 27 bar to about 50 bar or from about 35 bar to about 45 bar and a temperature of from about 38° C. to about 121° C., for example. Reaction heat may be removed through the loop wall via any method known to one skilled in the art, such as via a double-jacketed pipe or heat exchanger, for example.

Alternatively, other types of polymerization processes may be used, such as stirred reactors in series, parallel or combinations thereof, for example. Upon removal from the reactor, the polymer may be passed to a polymer recovery system for further processing, such as addition of additives and/or extrusion, for example.

In one or more embodiments, the heterophasic copolymers (also referred to herein as impact copolymers) are formed by incorporating a rubber fraction into the polymer matrix by methods known to one skilled in the art, such as via mechanical blending or co-polymerization, for example. The co-polymerization process may include at least two stages, wherein a first polymer, generally a homopolymer (e.g., polypropylene) is produced in a first reaction zone, the product of which is transferred to a second reaction zone for contact with a comonomer and additional monomer (e.g., propylene) to produce a rubber component of the heterophasic copolymer.

### Polymer Product

The polymers (and blends thereof) formed via the processes described herein may include, but are not limited to propylene based impact copolymers, for example. As used herein, the term “propylene based” refers to a polymer having at least about 80 wt. %, or at least about 85 wt. % or at least about 90 wt. % polypropylene.

The impact copolymers described herein generally include from about 5 wt. % to about 15 wt. % comonomer, or from about 8 wt. % to about 12 wt. % or from about 8.5 wt. % to about 10 wt. % comonomer, for example. In one or more embodiments, the comonomer is ethylene.

Unless otherwise designated herein, all testing methods are the current methods at the time of filing.

In one or more embodiments, the impact copolymers have a melt flow rate (as measured by ASTM D1238) of from at least about 5 dg./min., or from about 10 dg./min. to about 120 dg./min. or from about 15 dg./min. to about 30 dg./min., for example.

In one or more embodiments, the impact copolymers are blended with a second polymer to form modified impact copolymers. In one specific embodiment, the second polymer is a propylene homopolymer. As used herein, the term “propylene homopolymer” refers to those polymers composed primarily of propylene and limited amounts of other comonomers, such as ethylene, wherein the comonomer makes up less than about 2 wt. % (e.g, mini random copolymers), or less than about 0.5 wt. % or less than about 0.1 wt. % by weight of polymer. The modified polymer may include from about 5 wt. % to about 75 wt. % or from about 25 wt. % to about 50 wt. % propylene homopolymer, for example.

In one specific embodiment, the second polymer includes impact copolymers having a melt flow rate of at least about 80 dg/min., or from about 80 dg/min. to about 120 dg./min. or from about 90 dg/min. to about 115 dg./min. (e.g., high melt flow rate impact copolymers), for example. The modified impact copolymers may include from about 5 wt. % to about 40 wt. % or from about 10 wt. % to about 30 wt. % high melt flow rate impact copolymer, for example.

### Product Application

The polymers and blends thereof are useful in applications known to one skilled in the art, such as forming operations (e.g., film, sheet, pipe and fiber extrusion and co-extrusion as well as blow molding, injection molding and rotary molding). Films include blown, oriented or cast films formed by extrusion or co-extrusion or by lamination useful as shrink film, cling film, stretch film, sealing films, oriented films, snack packaging, heavy duty bags, grocery sacks, baked and frozen food packaging, medical packaging, industrial liners, and membranes, for example, in food-contact and non-food contact application. Fibers include slit-films, monofilaments, melt spinning, solution spinning and melt blown fiber operations for use in woven or non-woven form to make sacks, bags, rope, twine, carpet backing, carpet yarns, filters, diaper fabrics, medical garments and geotextiles, for example. Extruded articles include medical tubing, wire and cable coatings, sheet, thermoformed sheet, geomembranes and pond liners, for example. Molded articles include single and multi-layered constructions in the form of bottles, tanks, large hollow articles, rigid food containers and toys, for example.

In particular, embodiments of the invention (and particularly the impact copolymers described herein) are useful for forming fibers including yarn and filaments. As used herein, the term “yarn” refers to a fiber formed from short fibers spun together continuously. The term “filament” refers to a continuous yarn produced directly by extruding from liquid polymer.

Spunbond fibers or spunbond fabrics refer to small diameter fibers that are formed by extruding molten thermoplastic material as filaments from a plurality of fine, usually circular capillaries of a spinneret. The filaments are aspirated and deposited randomly onto a moving perforated belt, forming a web. Spunbond fibers are generally not tacky as they are deposited onto conveying belt. The web is typically bonded by heat or adhesives to form a non-woven scrim.

Spunbond non-woven yarns are generally continuous but not crimped. In one or more embodiments, the average diameter of the spunbond non-woven yarn is at least about 2 microns or from about 10 to 25 microns, for example. It has been observed that certain ICP blends disclosed herein exhibit high fiber spinnability, and are therefore suitable for making fine denier spunbond fabrics.

Meltblown fibers and meltblown fabrics refers to fibers formed by extruding a molten thermoplastic material through a plurality of fine, usually circular capillaries as molten filaments into converging high velocity gas streams which attenuate the filaments of molten thermoplastic material to reduce their diameter. Thereafter the meltblown fibers are carried by the high velocity gas stream and are deposited on a collecting surface to form a web of randomly dispersed meltblown fibers. Generally, meltblown fibers are microfibers that are either continuous or discontinuous and are generally smaller than 10 microns, or less than 5 microns, or from about 1 to about 3 microns in diameter. In addition, the meltblown fibers are generally tacky when deposited onto a collecting surface to form the fabric. It has been observed that certain ICP blends disclosed herein exhibit high fiber spinnability, and are therefore suitable for making fine denier meltblown fabrics.

In one or more embodiments, the article includes continuous fibers (e.g., filaments, which are referred to herein in specific embodiments as yarn). It has been observed that the filaments formed from embodiments of the invention generally result in improved resiliency, lower luster and softer hand than those applications utilizing propylene homopolymers. The yarn and filaments described herein may be used in applications known to one skilled in the art, such as carpet and textile applications.

In one or more embodiments, the article includes bulk continuous fibers (e.g., crimped continuous fibers). The bulk continuous fibers may be treated (e.g., texturized or crimped) by steam or hot air to give it three-dimensional bulk by imparting random loops thereto (crimping). The texturing process may include heating the fibers to slightly below the melting point fiber, deforming the fiber by turbulent air flow, a hot knife edge or steamjet, for example, and allowing the fiber to cool in the crimped state. Bulk continuous fibers generally result in increases cover, resilience, abrasion resistance, warmth, insulation, and moisture absorption than continuous fibers, for example.

Continuous fibers and bulked (or crimped) continuous fibers may be used in the production of floorcoverings, fabrics, belts and ropes, for example.

In one specific embodiment of the invention, the fibers (e.g., spunbond fabrics and meltblown fabrics) possess self-crimping characteristics. As used herein, the term “self-crimping” refers to a process that can either directly impart crimps as fibers are spun from fiber-spinning equipment or impart crimps by themselves as the as-spun fibers are elongated by end users without heat treatment, for example. The self-crimping fibers and fabrics are formed by the impact copolymers described above having a comonomer content of from about 7.5 wt. % to about 10.5 wt. %, or from about 8 wt. % to about 10 wt. % or from about 8.5 wt. % to about 9.5 wt. Industrially, spunbond and meltblown fabrics are made of straight fibers. The benefits of “self crimping” are significant and include cost savings, energy efficiency and safety, for example. Self-crimped spunbond and meltblown fabrics can also offer value added performance, including improved covering, hand feel, abrasion resistance, warmth, insulation and moisture absorption, for example.

In another specific embodiment of the invention, the article includes soft touch fibers. As used herein, the term “soft touch fiber” refers to the soft touch feel of a fabric, generally referred to as hand. Generally, both finer denier and lower modulus contribute to the “softness” feel of the fibers and fabrics. It has been discovered that certain blends of impact copolymers may possess significantly improved fiber spinnability, thereby making it possible to produce finer denier fibers from impact copolymers. It has further been observed that the soft touch fibers formed by the impact copolymers described herein also possess relatively lower modulus than those of homopolymer fibers. In one specific embodiment, the soft touch fibers are formed by impact copolymers modified with the high melt flow impact copolymer, as described above.

The soft touch fibers formed by the impact copolymers described above also experience improved extensibility. As used herein, the term “extensible” refers to the fiber, which, upon application of a biasing force, is elongatable to above 300%, or 400%, or from about 600% to about 800% without experiencing catastrophic failure, but not necessarily recovering all or any of the applied strain. In addition, the soft touch fibers can exhibit significant extensibility or cold drawability at relatively low force. For example, the soft touch fibers may exhibit a cold draw ratio of up to about 300%, for example.

The soft touch fibers described herein may be used in applications known to one skilled in the art, such as non-woven applications including diapers. As used herein, the term “non-woven” is used to describe fabrics made through means other than weaving or knitting.

### EXAMPLES

### Example 1

Partially oriented yarns (POY) were produced from a variety of impact copolymers (including blends thereof) at various draw conditions and fiber sizes. Polymer “A” refers to TOTAL Petrochemicals 3766, which is a metallocene produced propylene homopolymer (target MFR of 23.0 dg/min) commercially available from TOTAL Petrochemicals USA, Inc. Polymer “B” refers to TOTAL Petrochemicals 5724, which is a vis-broken impact copolymer (11.2 wt. % C₂, target MFR of 20 dg/min) commercially available from TOTAL Petrochemicals USA, Inc. Polymer “C” refers to TOTAL Petrochemicals 4520, which is a reactor produced impact copolymer (7.4 wt. % C₂, target MFR of 7 dg/min) commercially available from TOTAL Petrochemicals USA, Inc. Polymer “D” refers to TOTAL Petrochemicals 4920, which is a reactor produced impact copolymer (9.0 wt. % C₂, target MFR of 100 dg/min) commercially available from TOTAL Petrochemicals USA, Inc. Polymer “E” refers to a reactor grade metallocene random copolymer (target MFR of 11 dg/min).

Table 1 details the processing conditions for fiber formation.

TABLE 1
POY@2000 m/min

| | | | Polymer C/ | C/D/E |
|---|---|---|---|---|
| | Polymer A | Polymer B | Polymer D | blend |
| MFR (dg/min) | 23 | 20 | 16 | 16 |
| Denier (dpf) | 257 | 251 | 254 | 250 |
| Max Tenacity (g/den) | 2.95 | 0.96 | 1.22 | 1.00 |
| Tenacity at break (g/den) | 2.65 | 0.86 | 1.10 | 0.90 |
| Modulus at 5% | 2.83 | 1.84 | 1.00 | 1.59 |
| elongation (g/den) | | | | |
| Elongation at break (%) | 210 | 156 | 300 | 250 |
| Shrinkage (%) | 0.0 | 0.0 | 0.0 | 0.0 |

It was observed that the neat impact copolymers could barely be spun into partially oriented fibers at a maximum take-up speed of 2000 m/min, making it impossible to produce fine denier fibers that are necessary for spunbond and meltblown fabrics. However, by adding a small amount of high melt flow rate impact copolymer, the melt spinnability of the fibers was improved (up to 3500 to 4000 m/min), making it possible to make finer fibers, and thereby offering the potential for use in spunbond nonwoven applications.

### Example 2

Partially oriented yarns (POY) were produced from a variety of impact copolymers (including vis-broken materials and their blends thereof) at various draw conditions and fiber sizes. Polymer “A” refers to a 20 dg/min melt flow rate vis-broken material, which is an impact copolymer (6.0 wt. % C₂ target MFR of 2.0 dg/min. Polymer “B” refers to a 20 dg/min melt flow rate vis-broken blend material of 40 wt. % TOTAL Petrochemicals 3721 and 60 wt. % Total Petrochemicals 4280W, which are a propylene homopolymer (taget MFR of 1.6 dg/min) and an impact copolymer (target MFR of 1.3 dg/min, 10 wt. % C₂) respectively and commercially available from Total Petrochemicals USA, Inc. Polymer “C” refers to TOTAL Petrochemicals 4720, which is a reactor produced impact copolymer (9.0 wt. % C₂, target MFR of 25 dg/min) commercially available from TOTAL Petrochemicals USA, Inc. Polymer “D” refers to TOTAL Petrochemicals 5724, which is a vis-broken impact copolymer (11.2 wt. % C₂, target MFR of 20 dg/min) commercially available from TOTAL Petrochemicals USA, Inc.

Table 2 details the processing conditions for fiber formation.

TABLE 2

| | Throughput rates | | | |
|---|---|---|---|---|
| | 0.6 g/min/hole | | | |
| Resin | Polymer A | Polymer B | Polymer C | Polymer D |
| Total C2 (wt %) | 6 | 6 | 9 | 11.5 |
| MFR (g/10 min) | 20 | 20 | 25 | 20 |
| Max take-up (m/min) | 1600 | 4600 | 2800 | 1800 |

It was observed that the neat impact copolymers, either reactor grade or vis-broken, could barely be spun into partially oriented fibers at a maximum take-up speed of less than 3000 m/min, making it difficult to produce fine denier fibers that are necessary for spunbond and meltblown fabrics. However, vis-broken of two low MFR homopolymer and impact copolymer significant improved the maximum spinnability with a maximum take up speed of 4600 m/min, making it industrially feasible to make fine fibers, and thereby offering the potential for use in spunbond nonwoven applications.

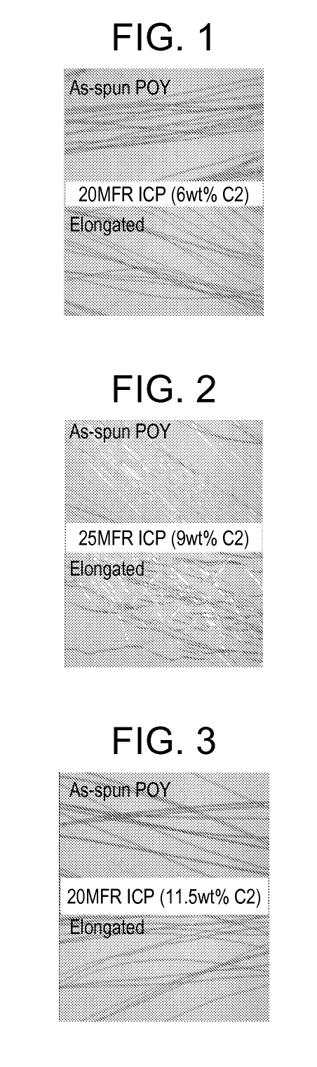

Unexpectedly, it was observed that the formed fibers were capable of self-crimping upon elongation without thermal treatment when the total ethylene content is about 9 wt. %. However, no self-crimping was observed when the ethylene content was about 6 wt. % or about 11.5 wt. %. See, FIGS. 1, 2 and 3.

### Example 3

Continuous filaments were produced from homopolymer and an impact copolymer at various draw conditions and fiber sizes. Polymer “A” refers to TOTAL Petrochemicals M3661, which is a metallocene propylene homopolymer (target MFR of 14 dg/min) commercially available from TOTAL Petrochemicals USA, Inc. Polymer “B” refers to TOTAL Petrochemicals 4820WZ, which is a reactor made impact copolymer (9.0 wt. % C₂, target MFR of 35 dg/min) commercially available from TOTAL Petrochemicals USA, Inc.

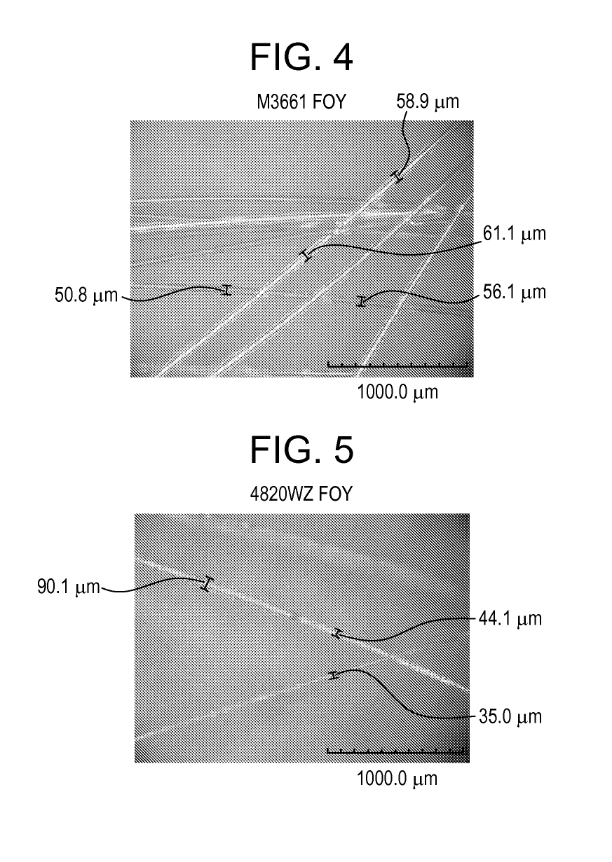

It was observed that impact copolymer could be made into fully oriented continuous filaments easily using the same conditions as those for homopolymer fiber grade. In comparison with homopolymer continuous filaments, impact copolymer continuous filaments appear to be dull and exhibit high coefficient of surface friction. Very rough surfaces and non-uniform thickness are observed (see, FIG. 4 and FIG. 5). Thus, impact copolymers can be very useful in some niche applications of continuous filaments or bulk continuous filaments where high surface friction is required.

### Example 4

Filaments (continuous filament yarn) were produced from a variety of impact copolymers (including blends thereof) at various draw conditions and fiber sizes. Polymer “A” refers to TOTAL Petrochemicals 3761, which is a propylene homopolymer (target MFR of 18 dg/min) commercially available from TOTAL Petrochemicals USA, Inc. Polymer “B” refers to TOTAL Petrochemicals 5724, which is a vis-broken impact copolymer (11.2 wt. % C₂, target MFR of 20 dg/min) commercially available from TOTAL Petrochemicals USA, Inc. Polymer “C” refers to TOTAL Petrochemicals 5720WZ, which is a reactor produced impact copolymer (11.0 wt. % C₂, target MFR of 20 dg/min) commercially available from TOTAL Petrochemicals USA, Inc. Polymer “D” refers to TOTAL Petrochemicals 4720, which is a reactor produced impact copolymer (9.0 wt. % C₂, target MFR of 25 dg/min) commercially available from TOTAL Petrochemicals USA, Inc. Polymer “E” refers to TOTAL Petrochemicals 4180, which is a reactor produced impact copolymer (11.0 wt. % C₂, target MFR of 0.75 dg/min) commercially available from TOTAL Petrochemicals USA, Inc.

Table 3 details the processing conditions for fiber formation, Table 4 details the properties of 10 denier/filament (about 33 μ) fibers and Table 5 details the properties of 20 denier/filament fibers.

TABLE 3

| Parameter | Setting |
|---|---|
| Temperature profile (° C.) | 200-205-210-220-230 |
| Spinnerets | 2 × 27 round hole - 0.6 mm D × 1.2 mm L |
| Target denier/dpf | 540/10, 1080/20 |
| Godet #1 (MPM/° C.) | 593, 445 |
| Draw Ratios | 3.0, 4.0, 5.0 |
| Godet #2 (MPM/° C.) | 1780/ambient |
| Godet #3 (MPM/° C.) | 1745/ambient |
| Winder speed (MPM) | Maintain 20 g tension |
| Rate | 1.8 gm/min/hole |

TABLE 4

| | | 3761 ZniPP | 5724 Blends %, | | | | 5720WZ Blends, % | | | | 4720 Blends, % | | | |
|---|---|---|---|---|---|---|---|---|---|---|---|---|---|---|
| Sample | | standard | 25 | 50 | 75 | 100 | 25 | 50 | 75 | 100 | 25 | 50 | 75 | 100 |
| FOY 3:1 | Tenacity at Maximum, gram/denier | 2.8 | 2.7 | 2.1 | 1.9 | 1.4 | 2.5 | 2.1 | 2.0 | 1.6 | 2.5 | 2.2 | 2.2 | 1.9 |
| Draw | Tenacity at Break, gram/denier | 2.5 | 2.4 | 1.9 | 1.7 | 1.2 | 2.2 | 1.9 | 1.8 | 1.4 | 2.3 | 2.0 | 2.0 | 1.7 |
| Ratio | Elongation at Maximum, % | 193 | 204 | 223 | 190 | 175 | 204 | 194 | 200 | 149 | 204 | 216 | 212 | 205 |
| | Elongation at Break, % | 204 | 222 | 239 | 208 | 192 | 216 | 217 | 219 | 174 | 221 | 230 | 231 | 229 |
| | Modulus at 5% Elongation, g/denier | 7.7 | 5.9 | 4.4 | 4.3 | 4.0 | 6.2 | 5.1 | 5.0 | 4.3 | 6.5 | 4.0 | 4.4 | 3.8 |
| | Shrinkage, % | 11.9 | 8.1 | 4.9 | 3.8 | 3.9 | 12.2 | 11.1 | 10.1 | 10.8 | 11.2 | 9.6 | 7.3 | 4.8 |
| FOY 4:1 | Tenacity at Maximum, gram/denier | 3.2 | 3.2 | 2.5 | 2.2 | 1.8 | 2.8 | 2.8 | 2.4 | 1.9 | 3.1 | 2.9 | 2.6 | 2.5 |
| Draw | Tenacity at Break, gram/denier | 2.9 | 2.8 | 2.3 | 2.0 | 1.7 | 2.5 | 2.5 | 2.1 | 1.7 | 2.8 | 2.6 | 2.4 | 2.2 |
| Ratio | Elongation at Maximum, % | 125 | 144 | 148 | 153 | 135 | 123 | 150 | 135 | 112 | 150 | 147 | 162 | 164 |
| | Elongation at Break, % | 140 | 168 | 165 | 172 | 151 | 143 | 160 | 146 | 129 | 163 | 162 | 174 | 176 |
| | Modulus at 5% Elongation, g/denier | 13.7 | 11.0 | 7.2 | 6.9 | 6.3 | 11.2 | 9.7 | 8.0 | 7.3 | 11.5 | 11.1 | 8.4 | 7.4 |
| | Shrinkage, % | 8.9 | 7.2 | 6.2 | 6.1 | 7.5 | 8.8 | 7.9 | 7.1 | 9.3 | 8.3 | 7.7 | 6.3 | 6.4 |
| FOY 5:1 | Tenacity at Maximum, gram/denier | | | 3.2 | | 2.1 | 3.3 | 3.1 | 2.7 | 2.2 | 3.8 | 3.2 | 3.0 | 2.8 |
| Draw | Tenacity at Break, gram/denier | | | 2.9 | | 1.9 | 3.0 | 2.8 | 2.4 | 2.0 | 3.4 | 2.9 | 2.7 | 2.6 |
| Ratio | Elongation at Maximum, % | | | 104 | | 106 | 101 | 93 | 84 | 67 | 93 | 100 | 113 | 114 |
| | Elongation at Break, % | | | 120 | | 121 | 113 | 107 | 99 | 85 | 103 | 115 | 126 | 125 |
| | Modulus at 5% Elongation, g/denier | | | 15.8 | | 8.3 | 15.9 | 16.2 | 14.5 | 12.0 | 18.2 | 15.5 | 14.8 | 13.3 |
| | Shrinkage, % | | | 8.6 | | 8.4 | 7.8 | 7.5 | 6.3 | 8.2 | 8.2 | 7.8 | 7.3 | 6.4 |

TABLE 5

| | | 3761 ZniPP | 5724 Blends, % | | | | 5720WZ Blends, % | | | | 4720 Blends, % | | | |
|---|---|---|---|---|---|---|---|---|---|---|---|---|---|---|
| Sample | | standard | 25 | 50 | 75 | 100 | 25 | 50 | 75 | 100 | 25 | 50 | 75 | 100 |
| FOY 3:1 | Tenacity at Maximum, gram/denier | 2.2 | 1.9 | 1.4 | 1.2 | 1.1 | 1.9 | 1.6 | 1.5 | | 1.9 | 1.8 | 1.7 | 1.4 |
| Draw | Tenacity at Break, gram/denier | 2.0 | 1.7 | 1.2 | 1.1 | 1.0 | 1.7 | 1.5 | 1.3 | | 1.7 | 1.6 | 1.5 | 1.3 |
| Ratio | Elongation at Maximum, % | 254 | 242 | 242 | 216 | 206 | 269 | 271 | 219 | | 267 | 268 | 263 | 271 |
| | Elongation at Break, % | 279 | 272 | 270 | 244 | 242 | 288 | 312 | 244 | | 293 | 287 | 303 | 298 |
| | Modulus at 5% Elongation, g/denier | 4.2 | 3.5 | 3.1 | 3.9 | 3.5 | 3.8 | 3.6 | 3.5 | | 4.0 | 3.6 | 3.1 | 2.6 |
| | Shrinkage, % | 7.0 | 7.0 | 5.9 | 7.2 | 9.7 | 7.0 | 5.9 | 6.8 | | 6.3 | 4.6 | 2.8 | 1.5 |
| FOY 4:1 | Tenacity at Maximum, gram/denier | 2.7 | 2.4 | 2.0 | 1.5 | 1.4 | 2.7 | 2.0 | 1.8 | | 2.5 | 2.5 | 2.1 | 1.9 |
| Draw | Tenacity at Break, gram/denier | 2.5 | 2.2 | 1.8 | 1.4 | 1.3 | 2.4 | 1.8 | 1.6 | | 2.3 | 2.2 | 1.9 | 1.7 |
| Ratio | Elongation at Maximum, % | 190 | 180 | 178 | 154 | 152 | 206 | 188 | 177 | | 191 | 216 | 210 | 209 |
| | Elongation at Break, % | 207 | 194 | 197 | 183 | 184 | 217 | 203 | 196 | | 206 | 229 | 220 | 228 |
| | Modulus at 5% Elongation, g/denier | 7.0 | 8.1 | 7.0 | 5.8 | 5.6 | 8.1 | 6.6 | 6.9 | | 6.3 | 6.3 | 6.3 | 5.8 |
| | Shrinkage, % | 6.6 | 7.6 | 8.4 | 9.3 | 11.8 | 6.7 | 5.5 | 6.6 | | 6.3 | 5.5 | 4.3 | 3.7 |
| FOY 5:1 | Tenacity at Maximum, gram/denier | | | 2.4 | | 1.8 | 3.0 | 2.8 | 2.4 | | 3.0 | 2.8 | 2.5 | 2.5 |
| Draw | Tenacity at Break, gram/denier | | | 2.2 | | 1.6 | 2.7 | 2.5 | 2.2 | | 2.7 | 2.5 | 2.2 | 2.3 |
| Ratio | Elongation at Maximum, % | | | 145 | | 121 | 133 | 140 | 133 | | 135 | 140 | 152 | 155 |
| | Elongation at Break, % | | | 161 | | 142 | 145 | 158 | 151 | | 150 | 155 | 161 | 167 |
| | Modulus at 5% Elongation, g/denier | | | 9.7 | | 9.2 | 12.3 | 10.9 | 9.9 | | 10.4 | 9.5 | 11.1 | 10.0 |
| | Shrinkage, % | | | 9.7 | | 11.7 | 7.4 | 6.6 | 7.4 | | 7.6 | 7.0 | 6.2 | 5.6 |

All samples except for blends containing Polymer E (4180) were capable of conversion into fibers. It was further observed that all of the formed fibers required higher draw ratios (from the standard 3:1) to achieve equivalent fiber tenacities and modulii compared to Polymer A (3761). At the higher or equivalent fiber tenacities and modulii allowed by mechanical stretching at 4:1 to 5:1 draw ratios, the impact copolymer blends generally showed lower fiber shrinkage than the comparative Polymer A produced at the standard 3:1 draw ratio (expect Polymer B when producing coarse fiber).

It was further observed that Polymers D and B generally delivered the greatest shift in the balance of fiber properties, with the narrower molecular weight distribution of Polymer B favoring properties for finer fiber and the broader molecular weight Polymer D favoring properties for coarse fiber. Further, all levels of the ICP blends showed significantly lower levels of fiber “luster” and gave a more cotton/wool-like appearance (measured by feel).

While the foregoing is directed to embodiments of the present invention, other and further embodiments of the invention may be devised without departing from the basic scope thereof and the scope thereof is determined by the claims that follow.

What is claimed is:

1. A fiber comprising:
a first polymer comprising a first propylene based impact copolymer; and
a second propylene based polymer.

2. The fiber of claim 1, wherein the second propylene based polymer is selected from propylene homopolymers and propylene based impact copolymers.

3. The fiber of claim 1, wherein the fiber is a soft touch fiber.

4. The fiber of claim 3, wherein the second propylene based polymer comprises a second propylene based impact copolymer exhibiting a melt flow rate of at least about 80 dg/min.

5. The fiber of claim 1, wherein the first propylene based impact copolymer comprises from about 3 wt. % to about 15 wt. % ethylene.

6. The fiber of claim 1, wherein the fiber is a fine denier filament suitable for making spunbond nonwoven or meltblown nonwoven articles.

7. The fiber of claim 1, wherein the first propylene based impact copolymer comprises from about 8 wt. % to about 11 wt. % ethylene and the fiber exhibits self crimping characteristics.

8. A fiber comprising:
a first polymer comprising a first propylene based impact copolymer; and
a second polymer comprising a propylene based homopolymer, wherein the first polymer and the second polymer are blended together and vis-broken to form a blend.

9. The fiber of claim 8, wherein the blend exhibits a melt flow rate of from about 15 dg/min. to about 60 dg/min.

10. The fiber of claim 8, wherein the first polymer and the second polymer individually exhibit melt flow rates of from about 0.1 dg/min. to about 5 dg/min.

11. The fiber of claim 8, wherein the fiber is a soft touch fiber.

12. The fiber of claim 8, wherein the first propylene based impact copolymer comprises from about 3 wt. % to about 15 wt. % ethylene.

13. The fiber of claim 8, wherein the fiber is a fine denier filament suitable for making spunbond nonwoven or meltblown nonwoven articles.

14. The fiber of claim 8, wherein the first propylene based impact copolymer comprises from about 8 wt. % to about 11 wt. % ethylene and the fiber exhibits self crimping characteristics.

15. A filament comprising:
a propylene based impact copolymer comprising from about 3 wt. % to about 15 wt. % ethylene.

16. The filament of claim 15, wherein the propylene based impact copolymer exhibits a melt flow rate of at least about 10 dg/min.

17. The filament of claim 15, wherein the filament is a continuous filament.

18. The filament of claim 15, wherein the filament is a bulk continuous filament.
